(19) United States
(12) Patent Application Publication
(10) Pub. No.: US 2009/0043921 A1
(43) Pub. Date: Feb. 12, 2009

(54) Method and System for Virtualization and Re-Direction of I/O Connections to Peripheral Devices

(76) Inventor: Protip Roy, San Diego, CA (US)

Correspondence Address: MCANDREWS HELD & MALLOY, LTD, 500 WEST MADISON STREET, SUITE 3400, CHICAGO, IL, 60661, US

(21) Appl. No.: 12/031,412

(22) Filed: Feb. 14, 2008

Related U.S. Application Data
(60) Provisional application No. 60/954,967, filed on Aug. 9, 2007.

(51) Int. Cl. G06F 13/14

(52) U.S. Cl. 710/31

(57) ABSTRACT

Methods and systems for virtualization and re-direction of I/O connections to peripheral devices are disclosed. Aspects of one method may include virtualizing one or more peripheral devices via corresponding PCI/PCIe level functions. The virtualization may comprise, for example, emulating peripheral device controllers. The PCI and/or PCIe level functions may then redirect accesses to peripheral devices to corresponding virtual devices. Since a PCI/PCIe level function may emulate a peripheral device controller, the redirecting may occur without modifying an operating system for the electronic system or the corresponding device driver used to access the peripheral device. Accordingly, virtualization and redirection may enable controlling a remote electronic system over a network. The controlling of a remote electronic system may comprise, for example, storing and accessing data in a remote storage device, booting from the remote storage device, and scanning and/or printing at the remote device.

### CROSS-REFERENCE TO RELATED APPLICATIONS/INCORPORATION BY REFERENCE

This application makes reference to, claims priority to, and claims benefit of U.S. Provisional Application Ser. No. 60/954,967 filed on Aug. 9, 2007. The above stated application is hereby incorporated herein by reference in its entirety.

### FEDERALLY SPONSORED RESEARCH OR DEVELOPMENT

[Not Applicable]

### MICROFICHE/COPYRIGHT REFERENCE

[Not Applicable]

### FIELD OF THE INVENTION

Certain embodiments of the invention relate to network communications. More specifically, certain embodiments of the invention relate to a method and system for virtualization and re-direction of I/O connections to peripheral devices.

### BACKGROUND OF THE INVENTION

A semiconductor component that provides a computer system with an interface to an external Network or to a LAN may be referred to as the Network Controller Chip (NCC). In today's computer systems, such an NCC may be integrated to the platform hardware via a PCI/PCIe bus.

A NCC may reside inside an electronic device. An electronic device, such as, for example, a personal computer, may feature several classes of external I/O ports, such as, for example, UART, USB, Keyboard-port, and a Mouse-port. In a legacy computer environment, local hardware I/O devices may be attached to these I/O ports. Some examples of local 10 devices are Mouse, Keyboard, UART TTY terminals, UART Modems, USB based Flash storage, and USB based External Hard Drive. The electronic device may comprise Operation System software (OS) that may establish I/O connections to these physical devices, and, hence, allow communication to these devices over the I/O connections.

In a legacy system, a NCC and an I/O controller may be functionally independent entities, although they might be connected via the same PCI/PCIe bus. A NCC and an I/O controller may also be co-located in the same chip and even share the same PCI/PCIe bus. But even then, these two classes of controllers may remain functionally independent.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method for virtualization and re-direction of I/O connections to peripheral devices, substantially as shown in and/or described in connection with at least one of the figures, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram of an exemplary local system that may be used in connection with an embodiment of the invention.

FIG. 2 is a block diagram of an exemplary network controller chip that may be used in connection with an embodiment of the invention.

FIG. 3 is a block diagram of an exemplary local system that illustrates virtual I/O redirection, in accordance with an embodiment of the invention.

FIG. 4 is a block diagram of an exemplary network controller chip that supports virtual I/O redirection, in accordance with an embodiment of the invention.

FIG. 5 is a block diagram illustrating virtual I/O redirection in transmitting to a virtual device, in accordance with an embodiment of the invention.

FIG. 6 is a block diagram illustrating virtual I/O redirection in receiving from a virtual device, in accordance with an embodiment of the invention.

### DETAILED DESCRIPTION OF THE INVENTION

Certain embodiments of the invention may be found in a method and system for virtualization and re-direction of I/O connections to peripheral devices. Aspects of the invention may comprise virtualizing one or more peripheral devices via corresponding PCI/PCIe level functions where a PCI/PCIe level function may be used to refer to a PCI level function for a PCI bus and/or a PCIe level function for a PCIe bus. The virtualization may comprise, for example, emulating peripheral device controllers. For example, by virtualizing a USB printer in a PCI/PCIe level function, a processor may be able to exchange data with the PCI/PCIe level function as if the PCI/PCIe level function was a USB printer. The PCI/PCIe level function may then redirect accesses to peripheral devices to corresponding virtual devices.

Since a PCI/PCIe level function may emulate a peripheral device controller, the redirection may occur without modifying an operating system for the electronic system or the corresponding device driver used to access the peripheral device. Accordingly, virtualization and redirection may enable controlling a remote electronic system over a network. The controlling of a remote electronic system may comprise, for example, storing and accessing data in a remote storage device, booting from the remote storage device, and scanning and/or printing at the remote device.

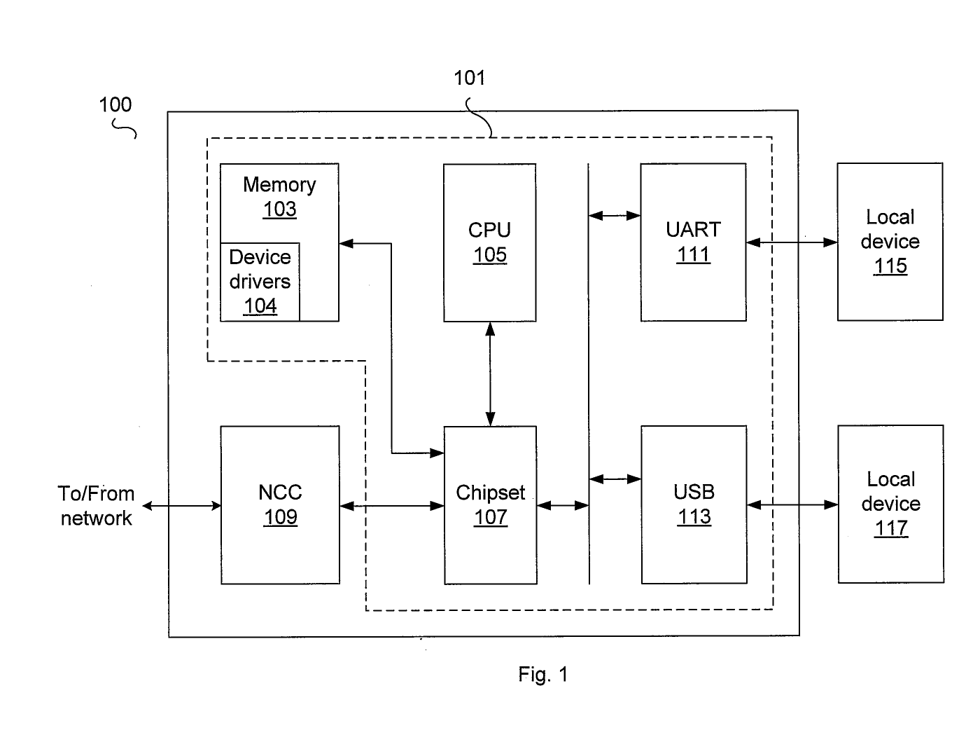

FIG. 1 is a block diagram of an exemplary local system that may be used in connection with an embodiment of the invention. Referring to FIG. 1 there is shown some components of a local system 100. The local system 100 may comprise, for example, a host system 101 and a network controller chip (NCC) 109. The host system 101 may comprise, for example, a memory block 103, a processor 105, a host chipset 107, a UART interface 111, a USB interface 113, and local devices 115 and 117. The UART interface 111 may enable communication with the local device 115, and the USB interface 113 may enable communication with the local device 117. The local system 100 may be an electronic device such as, for example, a personal computer, or a laptop, or a personal digital assistant. Each of the local devices 115 and 117 may be, for example, a mouse, a keyboard, UART teletype terminals, UART modems, USB based Flash storage, USB based external hard drive, or a USB based printer.

The memory block 103 may comprise device drivers 104. The device drivers 104 may be code and/or data that may allow a level of abstraction in accessing hardware, such as, for example, the NCC 109, and/or the USB interface 113. The processor 105 may communicate with the memory block 103 and the host chipset 107, and the host chipset 107 may communicate with the NCC 109. The NCC 109 may allow the local system 100 to communicate with other electronic devices via a wired network and/or wireless network. In this manner, the NCC 109 may transmit and/or receive data from a network.

The memory block 103 may comprise suitable logic, circuitry, and/or code that may be adapted to store a plurality of control, status and/or data information. The information stored in memory block 103 may be accessed by other processing blocks, such as, for example, the processor 105.

The processor 105 may comprise suitable logic, circuitry, and/or code that may be adapted to process data that may be read from, for example, the memory block 103. The processor 105 may store data in the memory block 103, and/or communicate data, status, and/or commands with other devices in the host system 101, such as, for example, the host chipset 107, and/or the NCC 109.

The host chipset 107 may comprise suitable logic, circuitry, and/or code that may be adapted to manage input/output data such as voice and/or data traffic from the processor 105 to the memory block 103 and/or peripheral devices. The peripheral devices may comprise, for example, storage devices, CD read and/or write drives, DVD read and/or write drives, printers, scanners, mouse(s), keyboards, terminals, modems. Storage devices may comprise, for example, floppy drives, hard disk drives, and FLASH memory. The peripheral devices may also comprise, for example, digital cameras, camcorders, MP3 players, personal digital assistants, mobile phones, and other devices that may be connected with an electronic device to exchange data of any type. The data may comprise, for example, multi-media files, voice information, commands, and/or status information.

The NCC 109 may comprise suitable logic, circuitry, and/or code that may be adapted to interface to one or more networks, such as, for example, a wireless network and/or a wired network. Accordingly, the local system 100 may communicate data with an Ethernet network. The UART interface 111 may comprise suitable logic, circuitry, and/or code that may be adapted to communicate to a local device 115 via a serial communication.

In operation, data may be communicated between the local system 100 and a network destination. Data may be received from a network source, for example, an external computer that may also be on the network, and the NCC 109 may indicate to the host system 101 that received data may be available. The data may then be processed by the processor 105 and/or saved in the memory block 103. Similarly, data in the memory block 103 and/or data provided by the CPU 105 may be communicated to a destination network device via the NCC 109.

The processor 105 in the host system 101 may also communicate data to the local devices 115 and 117. For example, the processor 105 may output, for example, data to be stored in the local device 115. The processor 105 may also output data to the local device 117 to be printed.

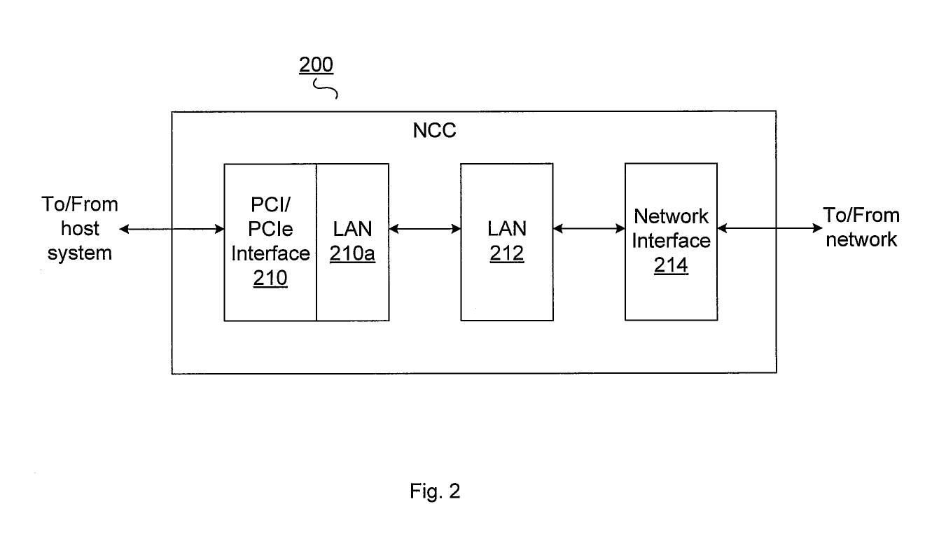

FIG. 2 is a block diagram of an exemplary network controller chip that may be used in connection with an embodiment of the invention. Referring to FIG. 2, there is shown the NCC 200, which may be similar to the NCC 109 described with respect to FIG. 1. The NCC 200 may comprise, for example, a PCI/PCIe interface 210, a LAN controller 212, and a network interface 214.

The PCI/PCIe interface 210 may comprise suitable logic, circuitry, and/or code that may be adapted to enable transfer of data between the NCC 200 and a host system, for example, the host system 101, via a PCI or a PCIe bus. The PCI/PCIe interface 210 may also comprise a PCI/PCIe level function 210a that enables the PCI/PCIe interface 210 to serve as a network interface controller function on a PCI/PCIe bus.

The LAN controller 212 may comprise suitable logic, circuitry, and/or code that may be adapted to communicate data received via the PCI/PCIe interface 210 to the network interface 214 for transmission onto a network. Similarly, the LAN controller 212 may be adapted to communicate data received via the network interface 214 to, for example, the CPU 105 and/or the memory block 103 in the host system 101 via the PCI/PCIe interface 210.

The network interface 214 may comprise suitable logic, circuitry, and/or code that may be adapted to communicate data from the LAN controller 212 to a network, and/or communicate data received from a network to the LAN controller 212.

While the terms PCI and PCIe may be joined together as the term PCI/PCIe for simpler reference, the term PCI/PCIe may refer to either PCI or PCIe, or to both PCI and PCIe.

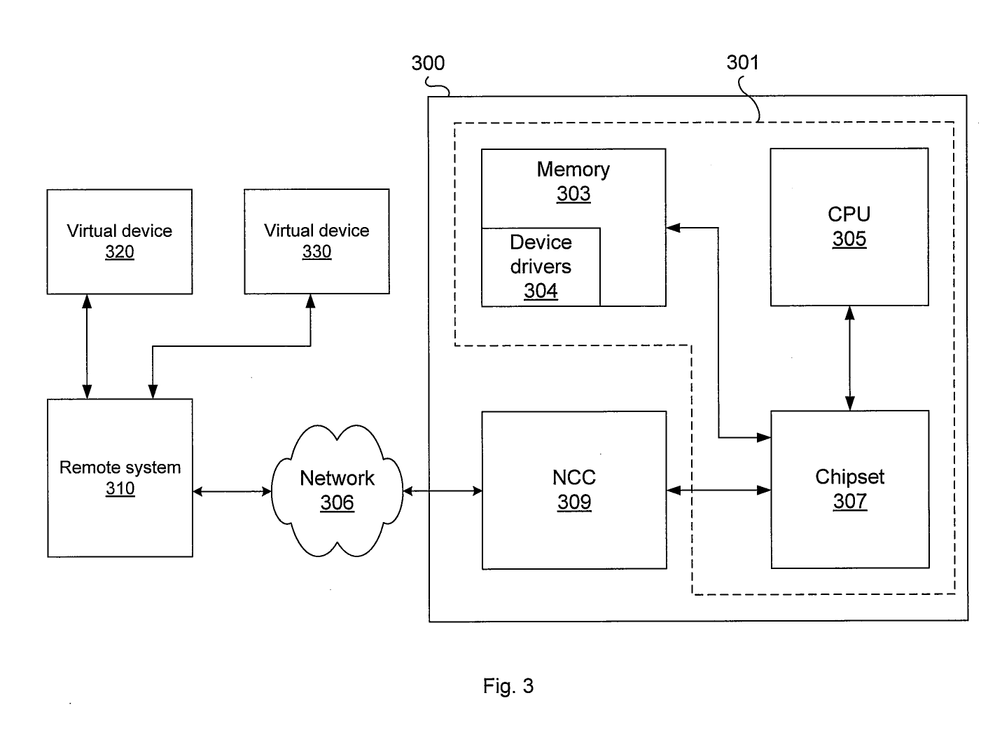

FIG. 3 is a block diagram of an exemplary local system that illustrates virtual I/O redirection, in accordance with an embodiment of the invention. Referring to FIG. 3, there is shown the local system 300, a network 306, a remote system 310, and virtual devices 320 and 330, which may be similar to, for example, the local devices 115 and 117. The network 306 may be a wired network and/or a wireless network. The local system 300 may be an electronic device similar, for example, to the local system 100. The local system 300 may also support, for example, virtual I/O redirection. The remote system 310 may be similar, for example, to the local system 100. Accordingly, the remote system 310 may host local devices 320 and 330, where each of the local devices 320 and 330 may be, for example, a mouse, a keyboard, UART teletype terminals, UART modems, USB based Flash storage, USB based external hard drive, or a USB based printer.

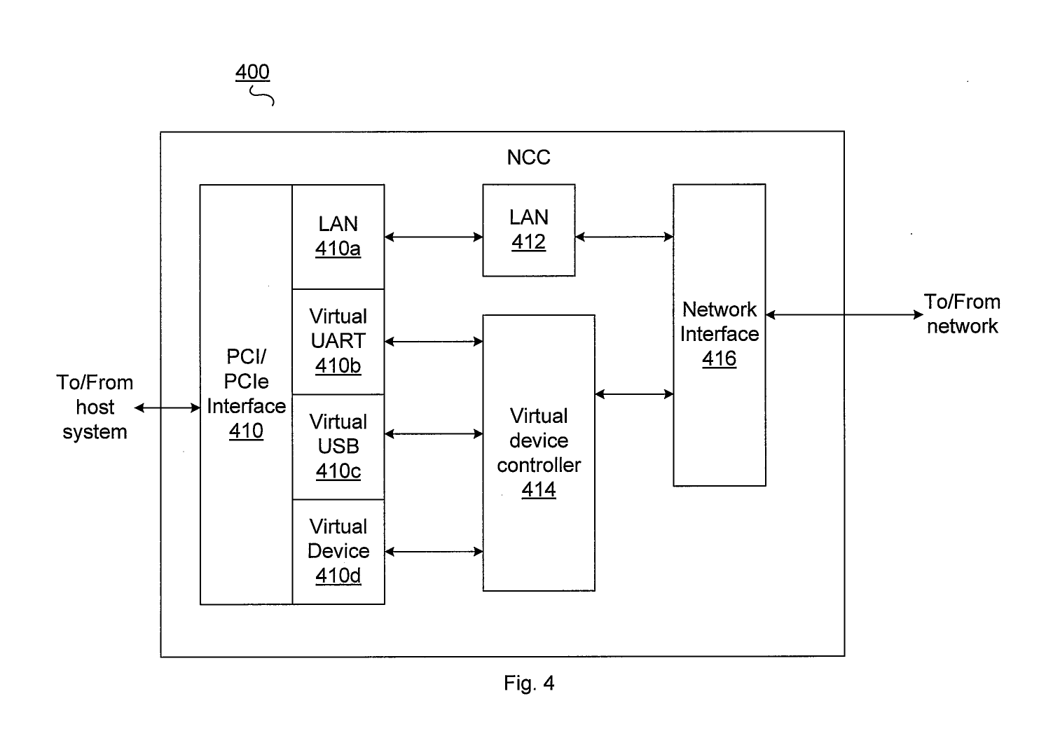

The local system 300 may comprise, for example, a host system 301 and a NCC 309. The host system 301 may comprise, for example, a memory block 303, a processor 305, and a host chipset 307, which may be similar to corresponding devices described with respect to FIG. 1. The local system 300 may support virtual I/O redirection. For example, the NCC 309 may be connected to the host system 301 as a network controller. The NCC 309 may present certain classes of virtual I/O controllers (described with respect to FIG. 4) to the host system 301 over a PCI/PCIe bus. Accordingly, the host system 301 may communicate to the NCC 309 as if physical I/O devices of industry standard characteristics, such as, for example, the local devices 115 and 117 may be connected to the NCC 309. Accordingly, various software in the host system 301 may perceive no fundamental or operational differences between the virtual devices 320 and 330 and local, physically connected peripheral devices such as, for example, the local devices 115 and 117. Additionally, an operating system and/or software drivers for the peripherals may not need to be modified to support virtual I/O redirection.

The NCC 309 may then establish connection with the virtual device 320 or 330, and allow the host system 301 to communicate with the virtual device as if the virtual device was a local device. However, as opposed to local termination of an I/O connection, the NCC 309 may packetize data from the host system 301 for transport over the network 306. Consequently, there may be a peer remote system 310 in the same network 306 that may be capable of communicating with the NCC 309, and eventually execute the I/O transactions issued to the virtual devices 320 and/or 330. The remote system 310 may implement a scheme to emulate the virtual devices 320 and/or 330 or may actually bridge the transported data to the virtual devices 320 and/or 330 physically connected to the remote system 310. Accordingly, an I/O device or controller may be virtualized, and then communication between the I/O device and the host system 301 may be re-directed over the network 306.

FIG. 4 is a block diagram of an exemplary network controller chip that supports virtual I/O redirection, in accordance with an embodiment of the invention. Referring to FIG. 4, there is shown the NCC 400, which may be similar to the NCC 309 described with respect to FIG. 3. The NCC 400 may comprise, for example, a PCI/PCIe interface 410, a LAN controller 412, a virtual device controller 414, and a network interface 416.

The PCI/PCIe interface 410 may comprise suitable logic, circuitry, and/or code that may be adapted to enable transfer of data between the NCC 400 and a host system, for example, the host system 301, via a PCI/PCIe bus. The PCI/PCIe interface 410 may also comprise a plurality of PCI/PCIe level functions 410a, 410b, 410c, and 410d. The various PCI/PCIe level functions 410a, 410b, 410c, and 410d may enable a single PCI/PCIe interface 410 to serve a plurality of devices on a single PCI/PCIe bus.

For example, the PCI/PCIe level function 410a may enable normal network access functionality for the host system 301. The PCI/PCIe level function 410b may be used to access virtual UART devices, for example, and the PCI/PCIe level function 410c may be used to access virtual USB devices, for example. The PCI/PCIe level function 410d may generally support another communication interface than UART or USB to access virtual devices.

Accordingly, the PCI/PCIe level functions 410b and 410c may enable the host system 301 to access the virtual devices 320 and/or 330 as if they were local devices physically connected to the local system 300. The PCI/PCIe level function 410d may enable accessing other virtual devices that may be connected via another type of communication interface, such as, for example, advanced technology attachment packet interface (ATAPI).

The LAN controller 412 may comprise suitable logic, circuitry, and/or code that may be adapted to communicate data received via the PCI/PCIe level function 410a in the PCI/PCIe interface 410 to the network interface 416 for transmission onto a network. Similarly, the LAN controller 412 may be adapted to communicate data received via the network interface 416 to, for example, the CPU 305 and/or the memory block 303 in the host system 301 via the PCI/PCIe level function 410a in the PCI/PCIe interface 410. Accordingly, the host system 301 may implement a network protocol stack, which may be for example, a TCP/IP stack, to facilitate network traffic through the NCC 309.

The virtual device controller 414 may comprise suitable logic, circuitry, and/or code that may be adapted to communicate data received via the PCI/PCIe level functions 410b, 410c, and/or 410d in the PCI/PCIe interface 410 to the network interface 416 for transmission onto a network. Similarly, the virtual device controller 414 may be adapted to communicate data received via the network interface 416 to, for example, the CPU 305 and/or the memory block 303 in the host system 301 via the PCI/PCIe level functions 410b, virtual USB 410c, and/or 410d in the PCI/PCIe interface 410. Accordingly, the virtual device controller 414 may implement a network protocol stack, which may be for example, a TCP/IP stack. This instance of a network stack may be essentially independent of the network stack implemented by the host system. This network stack shall be private to the Virtual device controller 414.

In operation, each of the PCI/PCIe level functions 410b, 410c, 410d may be viewed as an independent, legacy-compliant, virtual I/O controller since the legacy devices are not present in the NCC 400. Each of the PCI/PCIe level functions 410b, 410c, 410d may feature an address space and may be associated with one or more PCI interrupts. Such an address space may comprise of several PCI standard defined registers and a set of device specific registers. Various embodiments of the invention may emulate a corresponding address map and interrupt map of industry standard devices for a corresponding PCI/PCIe level function of the NCC 400. Accordingly, a legacy software driver for an I/O device may not be able to distinguish between a legacy I/O controller device physically connected to a PCI/PCIe bus and the virtualized I/O controller offered as an extension of the NCC 400.

In case of a virtual UART, for example, the register map of the industry standard 16550 UART controller may be mapped into the respective PCI/PCIe level function's address space. Host software may then be able to read or write into allowed registers of this UART. Firmware running in the PCI/PCIe level function 410b may emulate the 16550 operation by accepting a byte written by the host system 301 and also by depositing bytes into appropriate registers meant to be read by the host system 301. Accordingly, the host system 301 may communicate with, for example, the virtual device 320 as if the virtual device 320 was physically connected to the local system 300. In case of a virtual USB, for example, the register map of an open host controller interface (OHCI) compliant USB interface 113 may be mapped to a PCI/PCIe level function 410c.

A device driver software based in the device drivers 304 may issue transactions to a virtual 10 controller as it would issue to a physical controller inserted into a PCI bus. These transactions may comprise of transfer of data, and/or issuance of commands and reception of status. In various embodiments of the invention, such a transaction outbound to a virtual 10 device may be packetized and transported over the adjoining network interface 416 in the NCC 400.

Similarly, packets received by the NCC 400 that belong to a virtual I/O Connection may be de-packetized and forwarded to the respective device driver software via its PCI/PCIe level function 410b, 410c, 410d. This functionality in the PCI/PCIe level function 410b, 410c, 410d may be implemented via hardware and/or firmware.

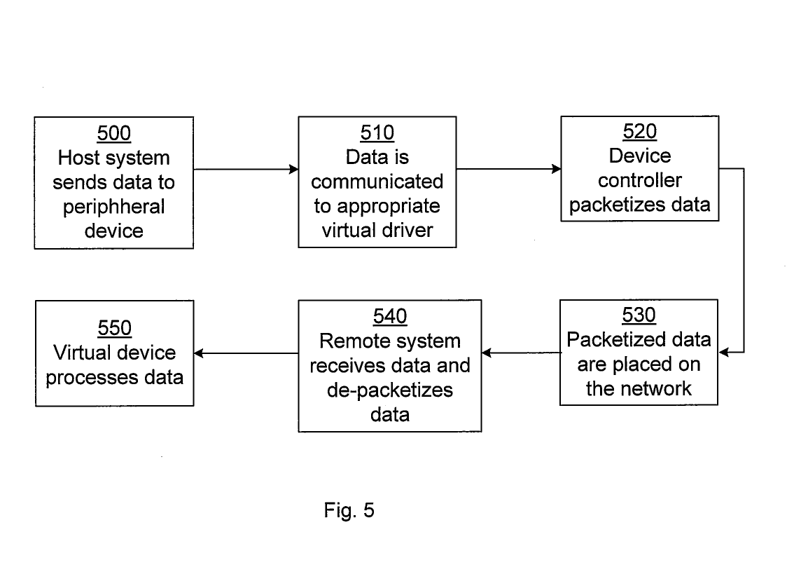

FIG. 5 is a block diagram illustrating virtual I/O redirection, in accordance with an embodiment of the invention. Referring to FIG. 5, in step 500, the local system 300 may, for example, send a file to be printed. The local system 300 may have registered the virtual device 320 as a local printer due to the virtualization of I/O connections to peripheral devices. For example, the PCI/PCIe level function 410c may be a virtual driver for the virtual device 320. Accordingly, the PCI/PCIe level function 410c may interface to the host system 301 as if it was an actual physical controller connected to a PCI/PCIe bus, such as, for example, the USB interface 113.

In step 510, the file to be printed may be communicated to the PCI/PCIe level function 410c by the host system 301. The PCI/PCIe level function 410c may communicate the data to be printed, as well as any print job commands, to the USB printer that may be the virtual device 320 via the virtual device controller 414. In step 520, the virtual device controller 414 may packetize the data to be sent to the virtual device 320 for transmission according to appropriate network protocol for the network 306.

In step 530, the packetized data may be communicated to the network interface 416, and the network interface 416 may transmit the data onto the network 306. In step 540, the remote system 310 may receive the data transmitted by the local system 300. Remote system may further de-packetize the data. The virtual device 320 may then receive de-packetized data from the remote system 310.

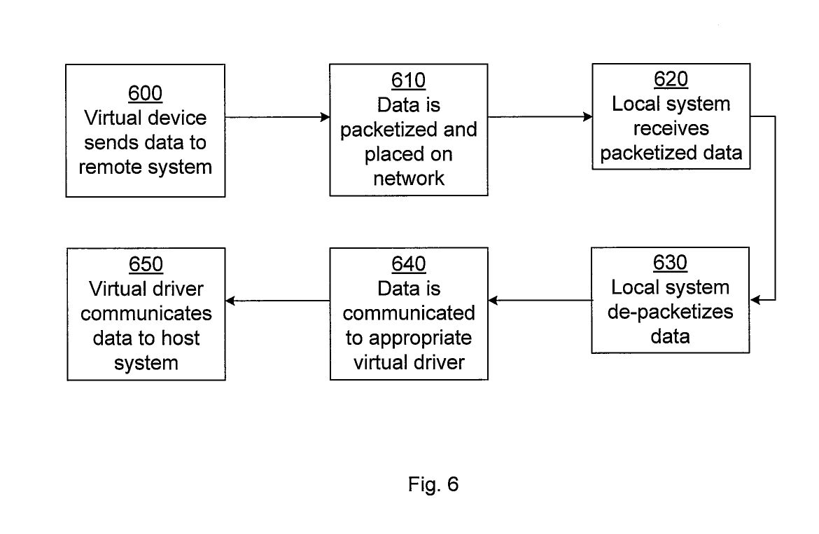

In step 550, the virtual device 320 may process the de-packetized data. Accordingly, the virtual device 320 may print the file as requested by the local system 300. The virtual device 320 may also communicate status information to the local system 300. Data transmitted by the virtual device 320 is described with respect to FIG. 6.

FIG. 6 is a block diagram illustrating virtual I/O redirection when receiving from a virtual device, in accordance with an embodiment of the invention. Referring to FIG. 6, in step 600, the virtual device 320 may, for example, communicate data to the remote system 310. The data may comprise, for example, status of the virtual device 320. The data may be sent via, for example, the network 306. In step 610, the remote system 310 may process the data for transmission according to protocol used for the network 306. The processing, which may comprise packetization, may be performed by the remote system 310.

In step 620, the packetized data may be received by the local system 300. The packetized data may be received by, for example, the virtual device controller 414 via the network interface 416. In step 630, the virtual device controller 414 may de-packetize the data received from the network 406. In step 640, the data may then be communicated to the appropriate PCI/PCIe level function 410b . . . 410d. In this regard, the PCI/PCIe level function 410c may be the virtual driver for the virtual device 320. Accordingly, the data may be communicated to the PCI/PCIe level function 410c by the virtual device controller 414.

In step 650, the data may be communicated to the host system 301 via the PCI/PCIe interface 410. The local system 300 may have registered the virtual device 320 as a local printer due to the virtualization of I/O connections to peripheral devices. Accordingly, the PCI/PCIe level function 410c may interface to the host system 301 as if it was an actual physical controller connected to a PCI/PCIe bus, such as, for example, the USB interface 113. Accordingly, it may appear to the host system 301 as if the virtual device 320 may be a local device, such as, for example, the local device 115 or 117, rather than a remote device on a network.

Accordingly, various embodiments of the invention may be used to enable a local system to boot via a virtual device. For example, a local computer may allow booting from a CD ROM. Accordingly, accesses to the CD ROM may be redirected to a virtual device and the local computer may boot according to instructions in the virtual device. Accordingly, various embodiments of the invention may enable booting a local system from a remote storage device. Similarly, when a virtual device is a printer and/or a scanner, the virtual device may be operated by the local system. Accordingly, various embodiments of the system may enable operation of one or more virtual devices by the local system.

Additionally, while various embodiments of the invention may have been described with respect to using a PCI/PCIe bus, the invention need not be so limited. Various embodiments of the invention may also be used for other bus and/or communication systems. Various embodiments of the invention may also enable the local system 300 to communicate with the local devices 115, 117, as well as being enable the local system 300 to communicate with the virtual devices 320, 330.

In accordance with an embodiment of the invention, aspects of an exemplary system may comprise, for example, PCI/PCIe level functions 410b, 410c, 410d, in the NCC 400 within an electronic system, such as, for example, the local system 300. Each of the PCI/PCIe level functions 410b, 410c, 410d may enable access to a corresponding virtual device, such as, for example, the virtual device 320, 330. Accordingly, the CPU 305, for example, may send commands, status, and/or data to a peripheral that may appear to be directly connected to the local system 300. The NCC 400 may redirect the commands, status, and/or data from the CPU 305 to a corresponding virtual device via a corresponding PCI/PCIe level function 410b, 410c, or 410d.

Since a PCI/PCIe level function 410b, 410c, 410d may emulate a peripheral device controller on a PCI/PCIe bus, an operating system for the local system 300 may not need to be modified. Similarly, the device drivers 304 that may be used by the local system 300 to access various peripheral devices may not need to be modified. Accordingly, the NCC 400 may enable remotely operating an electronic system over a network via the redirecting. For example, the local system 300 may store data to the virtual device 320, 330 that may be, for example, a hard disk drive. Similarly, the local system 300 may retrieve data from the virtual device 320, 330.

Accordingly, the local system 300 may be able to boot from the virtual device 320, 330 rather than from, for example, a locally connected hard disk drive. Similarly, the local system 300 may also scan and/or print a file to the virtual device 320, 330.

Another embodiment of the invention may provide a machine-readable storage, having stored thereon, a computer program having at least one code section executable by a machine, thereby causing the machine to perform the steps as described herein for virtualization and re-direction of I/O connections to peripheral devices.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will comprise all embodiments falling within the scope of the appended claims.

What is claimed is:

1. A method for communicating data, the method comprising:
virtualizing, within an electronic system, one or more peripheral devices via one or more corresponding PCI/PCIe level functions to create one or more corresponding virtual devices; and
redirecting accesses to said one or more peripheral devices to said corresponding one or more virtual devices via said one or more PCI/PCIe level functions.

2. The method according to claim 1, wherein said redirecting occurs without any modification to an operating system for said electronic system in support of said redirecting.

3. The method according to claim 1, wherein said redirecting occurs without any modification to corresponding device drivers used to access said one or more peripheral devices.

4. The method according to claim 1, comprising controlling a remote electronic system over a network via said redirecting.

5. The method according to claim 1, comprising remote storing of data for said electronic system.

6. The method according to claim 1, comprising remote accessing of data for said electronic system.

7. The method according to claim 1, comprising booting said electronic system via said redirecting to a storage device.

8. The method according to claim 1, comprising printing at a virtual device via said redirecting.

9. The method according to claim 1, comprising scanning at a virtual device via said redirecting.

10. A machine-readable storage having stored thereon, a computer program having at least one code section for communicating data, the at least one code section being executable by a machine for causing the machine to perform steps comprising:
virtualizing, within an electronic system, one or more peripheral devices via one or more corresponding PCI/PCIe level functions to create one or more corresponding virtual devices; and
redirecting accesses to said one or more peripheral devices to said corresponding one or more virtual devices via said one or more PCI/PCIe level functions.

11. The machine-readable storage according to claim 10, wherein said redirecting occurs without any modification to an operating system for said electronic system in support of said redirecting.

12. The machine-readable storage according to claim 10, wherein said redirecting occurs without any modification to corresponding device drivers used to access said one or more peripheral devices.

13. The machine-readable storage according to claim 10, wherein the at least one code section comprises code for controlling a remote electronic system over a network via said redirecting.

14. The machine-readable storage according to claim 10, wherein the at least one code section comprises code for remote storing of data for said electronic system.

15. The machine-readable storage according to claim 10, wherein the at least one code section comprises code for remote accessing of data for said electronic system.

16. The machine-readable storage according to claim 10, wherein the at least one code section comprises code for booting said electronic system via said redirecting to a storage device.

17. The machine-readable storage according to claim 10, wherein the at least one code section comprises code for printing at a virtual device via said redirecting.

18. The machine-readable storage according to claim 10, wherein the at least one code section comprises code for scanning at a virtual device via said redirecting.

19. A system for communicating data, the system comprising:
one or more circuits within an electronic system, wherein said one or more circuits enable virtualization of one or more peripheral devices via one or more corresponding PCI/PCIe level functions to create one more corresponding virtualized peripheral devices; and
said one or more circuits enable redirection of accesses to said one or more peripheral devices to said corresponding one or more virtualized devices via said one or more corresponding PCI/PCIe level functions.

20. The system according to claim 19, wherein said redirection occurs without any modification to an operating system for said electronic system in support of said redirection.

21. The system according to claim 19, wherein said redirection occurs without any modification to corresponding device drivers used to access said one or more peripheral devices.

22. The system according to claim 19, wherein said one or more circuits enable controlling a remote electronic system over a network via said redirection.

23. The system according to claim 19, wherein said one or more circuits enable remote storing of data for said electronic system.

24. The system according to claim 19, wherein said one or more circuits enable remote accessing of data for said electronic system.

25. The system according to claim 19, wherein said one or more circuits enable booting of said electronic system via said redirection to a storage device.

26. The system according to claim 19, wherein said one or more circuits enable printing at a virtual device via said redirection.

27. The system according to claim 19, wherein said one or more circuits enable scanning at a virtual device via said redirection.
